(19) United States
(12) Patent Application Publication
(10) Pub. No.: US 2013/0085851 A1
(43) Pub. Date: Apr. 4, 2013

(54) Targeted Advertising of Products Shown in Media Content

(71) Applicants: Jeff Pedro, Atlanta, GA (US); Cameron Scott Blandford, Yorktown, VA (US); Mark Foladare, Eastbrunswick, NJ (US)

(72) Inventors: Jeff Pedro, Atlanta, GA (US); Cameron Scott Blandford, Yorktown, VA (US); Mark Foladare, Eastbrunswick, NJ (US)

(73) Assignees: AT&T Intellectual Property I, L.P., Atlanta, GA (US); AT&T Mobility II, LLC, Atlanta, GA (US)

(21) Appl. No.: 13/249,670

(22) Filed: Sep. 30, 2011

(51) Int. Cl. G06Q 30/02

(52) U.S. Cl. 705/14.53

(57) ABSTRACT

A particular method includes receiving, at an advertising server, media content information for media content sent to a display device coupled to a media device. The method includes retrieving a list of items depicted in the media content based on the media content information. The method includes receiving, at the advertising server, user identification information of a viewer of the media content. The method includes retrieving user history information associated with the user identification information. The method also includes determining, at the advertising server, one or more items of interest to the viewer from the list of items based on the user history information.

### FIELD OF THE DISCLOSURE

The present disclosure is generally related to providing targeted advertising of items included in media content.

### BACKGROUND

Television programming may be separated into content and commercials. The effectiveness of commercials may be waning since viewers may obtain programming without commercials or record programming and skip the commercials when the viewers watch the recorded programming. In addition to, or in lieu of, providing commercials associated with television programming, some advertisers use product placement in media content (e.g., television programming, movies, music videos, etc.). Product placement may encourage viewers to purchase products shown in the media content.

Targeted advertising selects an advertisement and sends the advertisement to select individuals instead of broadcasting the advertisement to a general broadcast population. The select individuals may be more responsive to the advertisement than the general broadcast population. Advertising distributors and providers that enable targeted advertising (e.g., internet portals, television providers, access network providers, etc.) can increase their revenue per advertisement impression by providing targeted advertising options to service providers.

### BRIEF DESCRIPTION OF THE DRAWINGS

FIG. 1 is a block diagram of an embodiment of a system to provide targeted advertising of products shown in media content.

FIG. 2 is an embodiment of a portable computing device that depicts targeted advertising of products shown in media content.

FIG. 3 is a flow chart of a first particular embodiment of a method for providing targeted advertising of products shown in media content.

FIG. 4 is a flow chart of a second particular embodiment of a method for providing targeted advertising of products shown in media content.

FIG. 5 is a block diagram of an illustrative embodiment of a general computer system.

### DETAILED DESCRIPTION

An advertising server may provide targeted advertising of items shown in media content to one or more viewers of the media content. The advertising server may send a listing of one or more items determined to be of interest to a particular viewer to a device associated with the particular viewer. The listing may be determined based on the items shown in the media content and based on user history of the particular viewer. The listing may include images of the one or more items, descriptions of the one or more items, links associated with the one or more items, or combinations thereof. When a viewer selects a particular item sent to a device associated with the viewer, the device may use the link to access a web page where the viewer is able to receive additional information about the particular item, purchase the item, or both.

A subscriber to a service plan from a service provider may watch media content on a display device. The service plan enables the viewer to receive and view the media content. The service provider may provide multiple services to the subscriber including, but not limited to, the service plan for media content, internet access, and mobile communication device services. The service provider may maintain a user history database for each subscriber based on the services provided to each subscriber. For each subscriber, the user history database may include records of media content requested by the subscriber, internet sites visited by the subscriber, purchases made by the subscriber from devices associated with services provided by the service provider, location information (e.g., locations visited by portable devices associated with services provided by the service provider), and other information pertaining to devices associated with the subscriber. The user history database may also include a user editable profile for each subscriber.

The service provider may maintain or may have access to a media content items database. The media content items database may include a listing of items shown in particular media content and links associated with the items. The items may be products and services.

Before or during transmission of a particular media content item (e.g., a particular television program or movie), the advertising server may access the media content items database to determine available items associated with the particular media content item. The advertising server may access the user history database to retrieve user history information for viewers or potential viewers of the particular media content item. The advertising server may determine items of interest for a particular viewer based on the available items and based on the user history for the particular viewer. The advertising server may provide a notification to the particular viewer of the items of interest for the particular viewer. The advertising server may provide information about the items of interest for the particular viewer when a request for the information is received from the particular viewer.

In a particular embodiment, a system includes a processor and a memory accessible to the processor. The memory includes instructions executable by the processor to receive user identification information for a viewer of a media device. The memory includes instructions executable by the processor to retrieve user history information for the viewer from a user history database based on the user identification information. The memory includes instructions executable by the processor to receive media content information for media content sent by the media device to a display device. The memory includes instructions executable by the processor to retrieve a list of items depicted in the media content from a media content items database. The memory includes instructions executable by the processor to determine one or more items of interest from the list of items based on the user history information. The memory includes instructions executable by the processor to generate links to the one or more items of interest. The memory also includes instructions executable by the processor to send the links to at least one device associated with the viewer.

In a particular embodiment, a method includes receiving, at an advertising server, media content information for media content sent to a display device coupled to a media device. The method includes retrieving a list of items depicted in the media content based on the media content information. The method includes receiving, at the advertising server, user identification information of a viewer of the media content. The method includes retrieving user history information associated with the user identification information. The method also includes determining, at the advertising server, one or more items of interest to the viewer from the list of items based on the user history information.

In a particular embodiment, a tangible computer readable medium includes instructions, that when executed by a processor, cause the processor to receive media content information for media content sent to a display device. The tangible computer readable medium includes instructions, that when executed by the processor, cause the processor to retrieve a list of items depicted in the media content based on the media content information. The tangible computer readable medium includes instructions, that when executed by the processor, cause the processor to receive first user identification information of a first user based on presence of a first user device associated with the first user proximate to the display device while the display device receives the media content. The tangible computer readable medium includes instructions, that when executed by the processor, cause the processor to retrieve first user history information associated with the first user identification information. The tangible computer readable medium includes instructions, that when executed by the processor, cause the processor to receive second user identification information of a second user proximate to the display device based on presence of a second user device associated with the second user proximate to the display device while the display device receives the media content. The tangible computer readable medium includes instructions, that when executed by the processor, cause the processor to retrieve second user history information associated with the second user identification information. The tangible computer readable medium includes instructions, that when executed by the processor, cause the processor to generate a first set of links of items of interest to the first user from the list of items based on the first user history information. The tangible computer readable medium includes instructions, that when executed by the processor, cause the processor to generate a second set of links of items of interest to the second user from the list of items based on the second user history information. The tangible computer readable medium also includes instructions, that when executed by the processor, cause the processor to send the first set of links to the first user device.

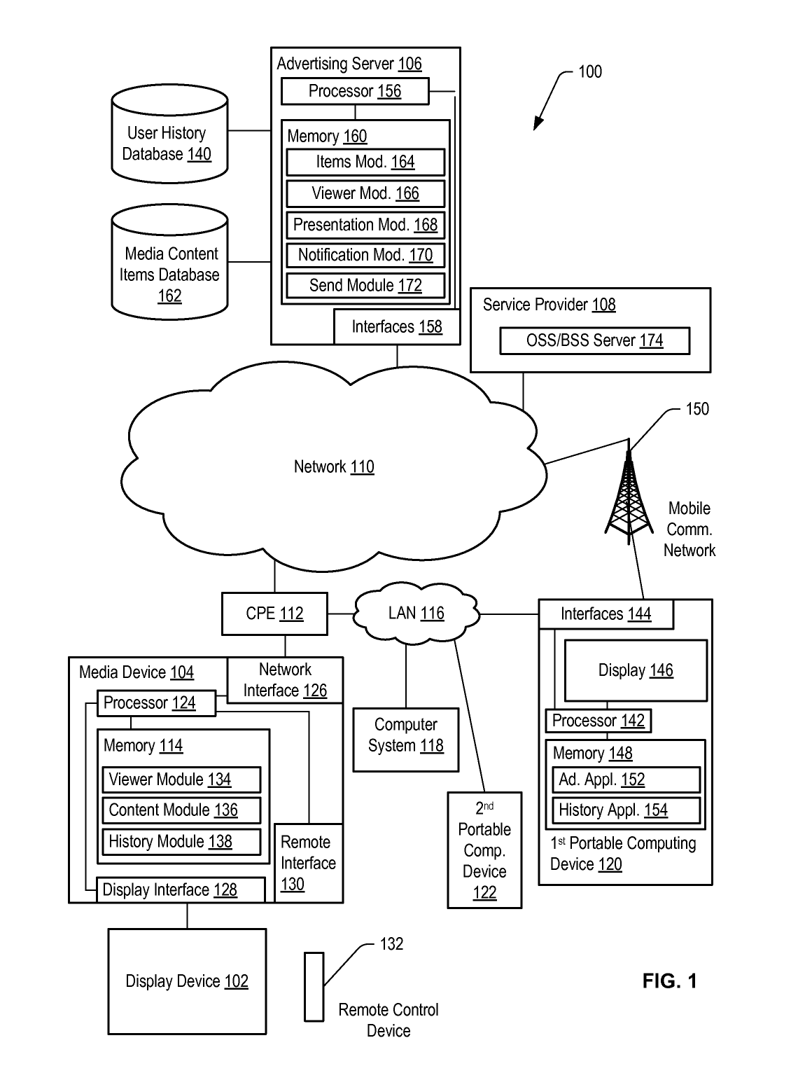

FIG. 1 is a block diagram of a particular embodiment of a system 100 to provide targeted advertising of products shown in media content. The system 100 may include a display device 102 that presents media content to one or more viewers. The display device 102 may receive the media content from a media device 104. The media device 104 may be a set-top box device or another device able to send media content to a display and to communicate with an advertising server 106. The media device 104 may be an integral component of the display device 102 or a separate component. The media content may be programming, such as television programming or pay per view programming, streamed by a service provider 108 to the media device 104 via a network 110 and customer premises equipment (CPE) 112. The media content may also be recorded content sent to the display device from a memory 114 of the media device 104 or from an external device (e.g., a digital video recorder) or memory coupled to the media device 104. The CPE 112 may facilitate communications to and from the network 110 and a local area network (LAN) 116 established by the CPE 112. The CPE 112 may include a router, a wireless router, a local area network device, a modem (e.g., a digital subscriber line (DSL) modem or a cable modem), a residential gateway, another communication device, or combinations thereof

The media device 104, the service provider 108, or both may send information about the media content to the advertising server 106. The media device 104, the service provider 108, or both may also send identification information to the advertising server 106. The identification information may indicate one or more viewers that are viewing the media content sent to the display device 102. In response, the advertising server 106 may determine items of interest for the one or more viewers. The items of interest may be items that are shown or depicted in the media content. When the advertising server 106 determines one or more items of interest for a particular viewer, the advertising server 106 may send a notification to one or more devices associated with the particular viewer. The notification may alert the particular viewer that additional information is available for one or more items shown in the media content. The one or more devices may include the display device 102, a computer system 118 (e.g., a desktop computer), a first portable computing device 120, a second portable computing device 122, or combinations thereof The computer system 118 may be located in the same room as the display device 102 so that a user of the computer system 118 is able to concurrently view the display device 102 and have access to the computer system 118. The first portable computing device 120 and the second portable computing device 122 may include mobile communication devices, tablet computers, personal digital assistants, lap top computers, other types of communication devices, or combinations thereof.

In response to the notification, the particular viewer may provide user input to request that the advertising server 106 send information regarding the one or more items of interest to a device associated with the particular viewer. When the advertising server 106 receives the request, the advertising server 106 may send the information to the device associated with the particular viewer. The information may include one or more links to items shown in the media content. The information may be presented in a manner that overlays the media content. When the particular viewer selects a link, the device may use the link to access a web page where the particular viewer can obtain additional information about the item corresponding to the link, receive an offer to purchase the item corresponding to the link, or both.

The media device 104 may include a processor 124. The processor 124 may be coupled to a network interface 126, a display interface 128, a remote interface 130, and the memory 114. The network interface 126 may enable the media device 104 to communicate via the network 110, via the LAN 116, or both. The display interface 128 may enable the media device 104 to send information to the display device 102. The remote interface 130 may enable the media device 104 to receive user commands from a remote control device 132, other input devices, or both.

The memory 114 may store data, such as settings for the media device 104, media content, and other information. The data may also include instructions executable by the processor 124 to perform tasks. For purposes of description, instructions for the media device 104 are illustrated in FIG. 1 as organized in functional modules. For example, the memory 114 may include a viewer module 134 to provide identification information for viewers of the display device 102 to the advertising server 106, a content module 136 to provide information associated with media content to the advertising server 106, and a history module 138 that provides usage information for one or more users of the media device 104 that may be stored at a user history database 140.

The viewer module 134 may receive identification information from one or more viewers, identification information of a user of the computer system 118, identification information regarding one or more portable devices, or combinations thereof. The viewer module 134 may receive identification information from one or more viewers of the display device 102 via the remote control device 132 or another input device. For example, a particular viewer may press a button of the remote control device 132 and a user name and password interface may be presented on the display device 102. The particular viewer may enter a user name and password to provide the identification information. The viewer module 134 may receive identification information regarding one or more portable devices from the CPE 112. For example, the viewer module 134 may send a request to the CPE 112 for identifiers of portable computing devices (e.g., the first portable computing device 120 and the second portable computing device 122) in the vicinity of the display device 102 that are able to connect to the LAN 116. In response, the CPE 112 may send identification information for one or more portable computing devices (e.g., the first portable computing device 120 and the second portable computing device 122) to the viewer module 134.

The viewer module 134 may send received identification information to the advertising server 106. The viewer module 134 may also provide information to the advertising server 106 that identifies one or more viewers that cease to view the media content sent to the display device 102 or that identifies one or more of the portable devices that are no longer in the vicinity of the display device 102. For example, a person that was identified as a viewer by having entered a user name and password may be identified as ceasing to view the media content when the person logs off from the media device 104. Information that the person has ceased to view the media content may be sent to the advertising server 106. As another example, the CPE 112 may determine that a particular portable device is no longer in the vicinity of the display device 102. The CPE 112 or the media device 104 may send information to the advertising server 106 indicating that the person associated with the portable device is no longer considered a viewer of the media content.

The content module 136 may send media content information identifying media content sent to the display device 102 to the advertising server 106. When the media device 104 sends media content received from the service provider 108 to the display device 102, the media content information may identify the particular programming received from the service provider 108. When the media content is recorded content, the media content information may include identification of the media content, the elapsed play time of the media content, a portion of metadata associated with the media content, other information that identifies the media content or a portion of the media content, or combinations thereof

The history module 138 may collect use information associated with the media device 104 for users of the media device 104. The use information may include viewing history, data for purchases made using the media device 104, web page access made using the media device 104, and other data pertaining to the use of the media device 104. The use information may be associated with one or more users of the media device 104. The use information may be sent to the user history database 140.

The first portable computing device 120 may include a processor 142. The processor 142 may be coupled to one or more interfaces 144, a display 146, and a memory 148. The second portable computing device 122 may also include a processor coupled to one or more interfaces, a display, and a memory. The one or more interfaces 144 may enable the first portable computing device 120 to communicate with the network 110 via the CPE 112, via a mobile communication network 150, or combinations thereof. The first portable computing device 120 may be associated with a service provider (e.g., the service provider 108) that enables the first portable computing device 120 to have access to the mobile communication network 150. The first portable computing device 120 may provide a user name, a password, other identifying credentials, or combinations thereof to gain access to the network 110 via the LAN 116. The LAN 116 may be a wireless local area network. The one or more interfaces 144 may also include a port that enables the first portable computing device 120 to be directly coupled to a device (e.g., the computer system 118 or a lap top computer) via a connector. Access to the device and to the network 110 may be provided to the first portable computing device 120 via the connector.

The display 146 may provide a visual interface to the user of the first portable computing device 120. In some embodiments, the display 146 may be a touch screen that enables user input to the first portable computing device 120. In some embodiments, the first portable computing device 120 may include a keyboard, a keypad, or another type of user interface in addition to, or in lieu of, the touch screen to enable user input.

The memory 148 may store data. The data may include settings for the first portable computing device 120, media content, and other information. The data in the memory 148 may also include instructions executable by the processor 142 to perform tasks. The instructions may include one or more applications to perform particular tasks. For example, the memory 148 may include an advertising application 152 and a history application 154.

The advertising application 152 may communicate with the advertising server 106. For example, the advertising server 106 may send notifications to the first portable computing device 120. A notification may inform a user of the first portable computing device 120 of the availability of information regarding one or more items shown in the media content sent to the display device 102 that may be of interest to the user. The first portable computing device 120 may perform an action to gain attention of the person associated with the first portable computing device 120 in response to the notification (e.g., ring, vibrate, make noise, display a pop-up interface, or combinations thereof). The first portable computing device 120 may receive user input requesting the information and may send a request for the information to the advertising server 106 via the network 110. The advertising server 106 may send the information to the first portable computing device 120 for viewing on the display 146.

The history application 154 may collect use information associated with the first portable computing device 120. The use information may include location data (e.g., locations visited by the first portable computing device 120), data regarding purchases made using the first portable computing device 120, web pages accessed using the first portable computing device 120, and other data pertaining to use of the first portable computing device 120. The use information may be sent to the user history database 140.

The advertising server 106 may include a processor 156. The processor 156 may be coupled to interfaces 158 and a memory 160. The interfaces 158 may enable the advertising server 106 to communicate with databases (e.g., the user history database 140 and a media content items database 162) and to communicate via the mobile communication network 150 and the network 110.

The memory 160 may include instructions executable by the processor 156. For purposes of description, instructions of the advertising server 106 are illustrated in FIG. 1 as organized in functional modules to perform particular tasks. The modules may include an items module 164, a viewer module 166, a presentation module 168, a notification module 170, and a send module 172.

The processor 156 may execute the items module 164 in response to receiving data from the media device 104 or the service provider 108 identifying media content sent to the display device 102. The items module 164 may send a query to the media content items database 162 with the data identifying the media content sent to the display device. In response to the query, the advertising server 106 may receive a list of items displayed in the media content in one or more upcoming scenes. The list may be sent to the presentation module 168.

The processor 156 may execute the viewer module 166 in response to receiving data from the media device 104 or the service provider 108 identifying one or more viewers of media content sent to the display device 102. The viewer module 166 may send a query with the data identifying the one or more viewers to an operation systems and support and billing systems and support (OSS/BSS) server 174 of the service provider 108. The OSS/BSS server 174 may determine whether the service provider 108 provides services for any of the viewers identified in the received data. For each of the one or more viewers who receive services from the service provider 108, the OSS/BSS server 174 may return to the viewer module 166 identification information. When the viewer module 166 receives the identification information from the OSS/BSS server 174, the viewer module 166 may send a query including the identification information to the user history database 140. In response to the query, the viewer module 166 may receive user history information for a viewer corresponding to the identification information. The user history information for each viewer identified by the OSS/BSS server 174 may be forwarded to the presentation module 168. The viewer module 166 may make a list of viewers of the media content at the display device 102. Additional viewers may be added to the list of viewers or existing viewers may be removed from the list of viewers based on additional viewer information received from the media device 104.

The presentation module 168 may be executed by the processor 156 to determine whether one or more items from the list may be of interest to the viewers in the list of viewers. The determination for a particular viewer may be based on the user history information for the particular viewer. The user history information may include data from an editable user profile and use information from one or more devices associated with the particular viewer. Information regarding the items of interest for the particular viewer may be sent to the send module 172. The information may include indicia descriptive of the one or more items of interest, images, audio or video data descriptive of the one or more items of interest, or combinations thereof. The information may also include a link corresponding to each item of the one or more items of interest. When a viewer of the information selects a link associated with a particular item, the device may be directed to a web page that enables the viewer to access additional information regarding the particular item, that enables the viewer to purchase the particular item, or both.

When the presentation module 168 determines one or more items of interest for the particular viewer, the notification module 170 may be executed by the processor 156 to send a notification to one or more contact devices associated with the particular viewer. The one or more contact devices may be identified based on the data received by the advertising server 106 that identifies the one or more viewers. The notification may offer to send information regarding the one or more items of interest to a device associated with the particular viewer. The device may be the contact device or another device associated with the particular viewer. For example, the device may be the display device 102, the computer system 118, the first portable computing device 120, or the second portable computing device 122. The particular viewer may choose to ignore the notification, view the information, or to have the information saved to the device for later viewing.

When the advertising server 106 receives a response from the contact device requesting the information, the send module 172 may send the information to the device associated with the viewer (e.g., the contact device or another device). The media content sent to the display device 102 may also be sent to the device associated with the viewer to underlie the information or otherwise be shown with the information. The send module 172, the media device 104, or both may synchronize the information with the media content being sent to the display device 102.

The system 100 may be used to provide targeted advertising of items shown in media content to viewers of the media content. For example, the media content may be programming selected by a first viewer via the remote control device 132. The programming may be sent to the media device 104 from the service provider 108. The media device 104 may send the programming to the display device 102. The first viewer may be associated with the media device 104. For example, the first viewer may be a member of a family where the media device 104 resides.

The media device 104 may determine that the first portable computing device 120 and the second portable computing device 122 are in the vicinity of the display device 102. The first portable computing device 120 may be associated with the first viewer (e.g., the first portable computing device 120 may be a tablet computer or a mobile communication device associated with the first viewer). The second portable computing device 122 may be associated with a second viewer (e.g., the second portable computing device 122 may be a mobile communication device associated with the second viewer). The second viewer may or may not be associated with the media device 104. For example, the second viewer may be a guest at the residence of the first viewer. The first portable computing device 120 and the second portable computing device 122 may both receive services from the service provider 108.

The media device 104 may send information about the media content to the advertising server 106. The media device 104 may also send information about the first portable computing device 120 and the second portable computing device 122 to the advertising server 106.

The advertising server 106 may query the media content items database 162 to receive a list of items shown in the media content (e.g., in an upcoming scene). The advertising server 106 may send additional queries to update the list as time advances, as one program ends and another begins, as a viewer changes media content being viewed (e.g., changes a channel being viewed), or at other times. The advertising server 106 may determine identification information for the first viewer and the second viewer based on the received information about the first portable computing device 120 and the second portable computing device 122, or based on user identification information provided by one or both of the viewers. The advertising server 106 may retrieve user history information from the user history database 140 for the first viewer and the second viewer based on the identification information. The advertising server 106 may create first information descriptive of items of interest to the first viewer based on the list of items and the user history information for the first user. The advertising server 106 may create second information of items of interest to the second viewer based on the list of items and the user history information for the second user. The items described in the first information may be the same items or different items than the items described in the second information.

The advertising server 106 may send a notification regarding the first information to the first portable computing device 120. The notification may cause the first portable computing device 120 to alert the first viewer and to make an offer to receive the first information. The offer may include a first selectable option that requests that the first information be sent to the first portable computing device 120 and a second selectable option that requests that the first information be sent to the display device 102 since the first viewer is associated with the media device 104 and the first portable computing device 120. When the first viewer elects to receive the first information, the first information may be sent by the advertising server 106 to the device designated by the first viewer. The first information may be updated by the advertising server 106 to change as the media content changes (e.g., due to scene changes). The first information may include a selectable save option that enables the first viewer to save the first information or a portion of the first information. The selectable save option may enable the first viewer to review items of interest at a later time.

The advertising server 106 may send a notification regarding the second information to the second portable computing device 122. The notification may cause the second portable computing device 122 to alert the second viewer and to make an offer to receive the second information. The offer may include a selectable option that requests that the second information be sent to the second portable computing device 122. In a particular embodiment, the offer may not include a selectable option regarding which device is to receive the second information when the second portable computing device 122 is the only device present or available that is associated with the second viewer. When the second viewer elects to receive the second information, the second information may be sent by the advertising server 106 to the second portable computing device 122. The second information may be updated by the advertising server 106 to change as the media content changes. The second information may include a selectable save option that enables the second viewer to save the second information or a portion of the second information.

When the first portable computing device 120 is turned off or leaves a predefined area (e.g., a coverage area of the LAN 116), the media device 104 may receive notification that the first portable computing device 120 is no longer in the vicinity of the display device 102. In response, the media device 104 may send data to the advertising server 106 to indicate that the first viewer is no longer a viewer of the media content. The advertising server 106 may cease determining items of interest associated with the media content for the first viewer. When the first viewer is receiving the first information, the advertising server 106 may send a query that asks the first viewer whether the first viewer wants to continue to receive the first information. When the advertising server 106 receives a response that the first viewer wants to continue receiving the first information, the advertising server 106 may continue sending the first information to the first viewer. When the advertising server 106 receives no response within a set time period or when the advertising server 106 receives a response that the first viewer does not want to continue receiving the first information, further communication of the first information is stopped.

In an embodiment, the advertising server 106 may send a notification of the availability of items of interest to a device associated with a particular viewer when the advertising server 106 receives information identifying the particular viewer. The notification may include an offer to view items of interest to the particular viewer that are shown in the media content. When the particular viewer does not respond after a set period of time, the notification may be sent to the device of the particular viewer again. This process may be repeated until the particular viewer sends a response to the advertising server 106, for a predetermined period of time, or for a predetermined number of notifications. The particular viewer may respond to the notification in a number of ways. For example, the particular viewer may send a first response to the advertising server 106 indicating that the particular viewer does not wish to view items of interest. When the advertising server 106 receives the first response, the advertising server 106 may remove the particular viewer from the listing of viewers of the media content. In another example, the particular viewer may send a second response to the advertising server 106 indicating that the particular viewer wishes to receive the items of interest for viewing on a particular device. When the advertising server 106 receives the second response, the advertising server 106 may provide the media content and the information regarding one or more items of interest for the particular viewer to the device specified by the particular viewer.

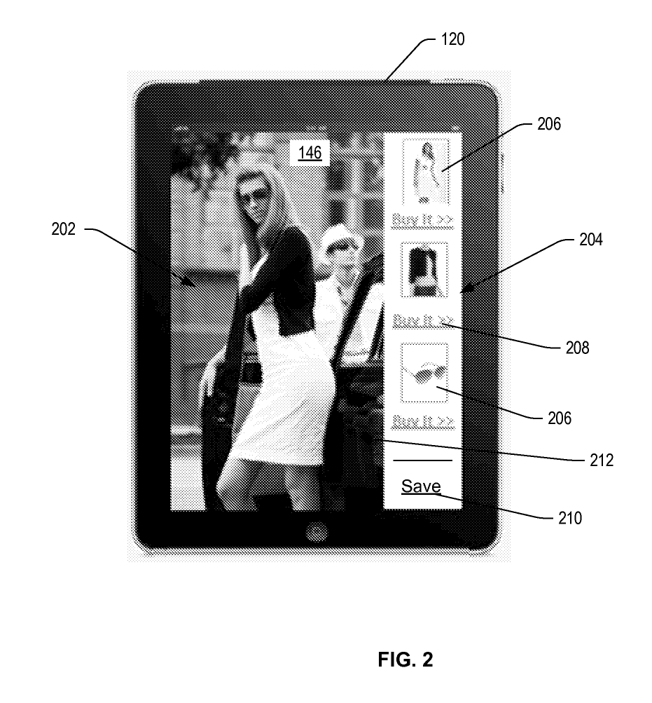

Referring to FIG. 2, an embodiment of the first portable computing device 120 is shown. Media content 202 that is also being sent to a display device (e.g., the display device 102 shown in FIG. 1) may be provided at a first portion of the display 146. A first presentation 204 may be provided at a second portion of the display 146. In a particular embodiment, the first presentation 204 includes icons 206 of items shown in the media content 202. A selectable link 208 may be associated with each icon 206. The selectable link may include text, the icons, or both. When a user of the first portable computing device 120 selects a selectable link 208 associated with a particular item, the first portable computing device 120 may show on the display 146 a web page that enables the user to access additional information regarding the particular item, that enables the user to purchase the particular item, or both. The presentation 204 may also include a selectable save icon 210 that saves the presentation when selected.

In an embodiment, the icons for the item or items of interest may overlay the media content at or in proximity to the item or items of interest in the media content. In a particular embodiment, the icons may be pop-up icons that become visible when the user activates a particular portion of the display 146 (e.g., when the user touches a particular location of the display 146).

In an embodiment, the information sent to the first portable computing device 120 may not include the media content. The media content may continue being sent to the display device (e.g., the display device 102 shown in FIG. 1). The first portable computing device 120 may receive from the advertising server information about links to the item or items of interest for the user of the first portable computing device 120. Based on the information, the first portable computing device 120 may send one or more selectable icons corresponding to the one or more selectable items to the display 146.

The links for the items shown in the presentation 204 may be selected for the person associated with the first portable computing device 120 based on user history information associated with the person. Another device displaying targeted advertising for a second person may show links for different items from the media content 202. For example, a second device associated with a second person may display links for a car 212.

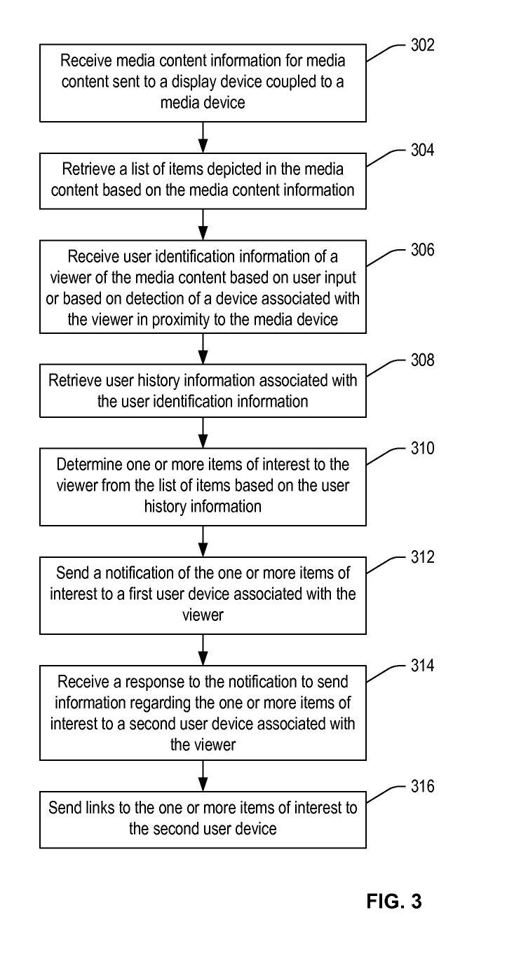

Referring to FIG. 3, a flow chart of a first particular embodiment of a method of providing targeted advertising of products depicted in media content is shown. The method may be performed, for example, by the system 100 of FIG. 1.

At 302, media content information may be received. The media content information may be received by an advertising server (e.g., the advertising server 106 of FIG. 1). The media content information may include information descriptive of media content sent to a display device coupled to a media device. The media device may be a device capable of receiving media content from a service provider. For example, the media device may be a set-top box device, a computer system (e.g. a desktop computer or a laptop computer), a tablet computer, a mobile communication device, or other device. The media content information may identify a title of the media content when the media content is provided to the media device by a content provider. The advertising server may query the content provider to determine additional media content information including, but not limited to, version identification information for the media content, elapsed playtime of the media content, metadata descriptive of an upcoming scene, or combinations thereof. The media content information may identify the media content title, media content version, elapsed playtime, metadata descriptive of an upcoming scene, or combinations thereof when the media content is media content played from a recording.

A list of items depicted in the media content may be retrieved based on the media content information, at 304. For example, the list may be retrieved by the advertising server from a media content items database. The list may include goods and services depicted in the media content.

User identification information of one or more viewers of the media content may be received, at 306. The user identification information may be based on user input received at the media device (e.g., a user name and a password), may be based on an identity of a user associated with the media device, may be based on detection of proximity of a device associated with the viewer to the media device, may be based on other information received by or stored at the media device or a residential gateway, or may be based on combinations thereof. For example, a first viewer may enter a username and a password at the media device via a remote control device. The media device may retrieve user identification information of the first viewer based on the username and password. The user identification information of the first viewer may be sent to the advertising server via the residential gateway. A second viewer may be a visitor to a residence associated with the first viewer. The second viewer may have a mobile communication device. The residential gateway may detect the presence of the mobile communication device in proximity to the media device (e.g., within the same room as the media device). When the mobile communication device is in proximity to the media device for a threshold period of time, the residential gateway may query the mobile communication device for information that identifies the mobile communication. The residential gateway may receive the information and send the information to the advertising server as identification information of the second viewer.

User history information associated with the user identification information may be retrieved, at 308. The user history information may be retrieved by the advertising server from a history information database based on a query that includes identity data. The advertising server may determine the identity data from received user identification information. For example, the server may send received identification information to an operation systems and support and billing systems and support (OSS/BSS) server of a service provider. The OSS/BSS server may return the identity data corresponding to the identification information. The identity data may correspond to database entries used to associate information with the viewers.

The user history information may include information from an editable profile, information acquired from one or more devices associated with the viewer, information gathered from other data sources (e.g., third party data services), or combinations thereof. The editable profile may identify viewer data (e.g., gender, date of birth, residence address, days of interest for the viewer (e.g., anniversary date, birthdays of selected people, etc.) and preferences for the user). The preferences may include particular categories of interest to the viewer or particular categories that are not of interest to the viewer. The viewer may access the editable profile associated with the viewer via a web page that provides access to entries of the database when the identity of the viewer is validated.

The user history information may include information acquired from one or more devices associated with the viewer. For example, the viewer may subscribe with a service provider to receive services for the one or more devices. The services may include a data service to receive information and voice over internet protocol communications via the internet, a television service to receive media content (e.g., music, radio programming, television programming, pay-per view programming, movies-on-demand, other programming, and combinations thereof), and communication services to receive communications via a mobile communication device, a land-line phone, or both. The service provider may associate particular user identification information with the viewer regardless of the particular service that the viewer uses. The service provider may provide the one or more devices with media content, communication services, internet access, or combinations thereof. The one or more devices may include, but are not limited to, a mobile communication device, a set-top box device, and one or more computers (e.g., desktop computers, laptop computers, and tablet computers). The service provider may collect usage data pertaining to purchase history, location history for portable devices, internet access history, media viewing patterns, other information, or combinations thereof. The location history for a portable device may track locations where the viewer takes the portable device. Location history may determine a normal travel pattern for the viewer. When the viewer deviates from the normal pattern, additional data may be obtained. For example, when the viewer deviates from a normal route to go to a mall, data pertaining to which stores in the mall the viewer enters and spends significant time in may be obtained and stored in the history database. When the viewer purchases an item or items in a store using the portable device to complete the transaction, data pertaining to the item or items purchased may also be obtained and stored in the history database.

One or more items of interest to the viewer may be determined from the list of items based on the user history information, at 310. For example, user history information for a first viewer of a particular program in Austin, Tex. and user history information for a second viewer of the particular program in Chicago, Ill. may indicate that each recently looked at web pages for watches and for a particular style of pants. The user history information may indicate that the first viewer purchased a watch via a web page and that the second viewer did not purchase a watch. The particular television program may show a scene where an actress is wearing a watch and the particular style of pants. A server that processes advertising for the first user may determine based on the user history information of the first user that the particular style of pants are of interest to the first user, but not the watch, since the first user recently purchased a watch. A server that processes advertising for the second viewer may determine based on the user history information of the second user that the particular style of pants and the watch are of interest to the second user.

A notification of the one or more items of interest to the viewer may be sent to a first device associated with the viewer, at 312. The first device may be the display device or another device associated with or designated by the viewer. For example, when the media device is associated with the viewer, the notification may be an icon displayed on the display device. When the viewer uses a remote control device to select the icon, the display device may present a first option to show the one or more items of interest as a separate window on the display device along with the media content. The display device may present a second option to display the one or more items of interest on a device selected by the viewer. The display device may present a third option to save the information regarding the one or more items of interest for later viewing. The display device may also present a fourth option to exit without viewing the items of interest. The display device may present fewer options or additional options. As another example, when the media device is associated with the viewer, the notification may be an icon displayed on the display device and the notification may also be sent to a portable communication device associated with the viewer.

As a further example, when the viewer is one of several viewers of the display device or when the viewer is not associated with the media device, the notification may be sent to a portable computing device associated with the viewer, such as a mobile communication device or a tablet computer. The notification may cause the portable communication device to generate an audible alert, vibrate, display a pop-up interface, or combinations thereof to attract the attention of the viewer.

A response to the notification to send the one or more items of interest to a second user device associated with the viewer may be received, at 314. For example, the response may be received by the advertising server. Links to the one or more items of interest may be sent to the second user device, at 316.

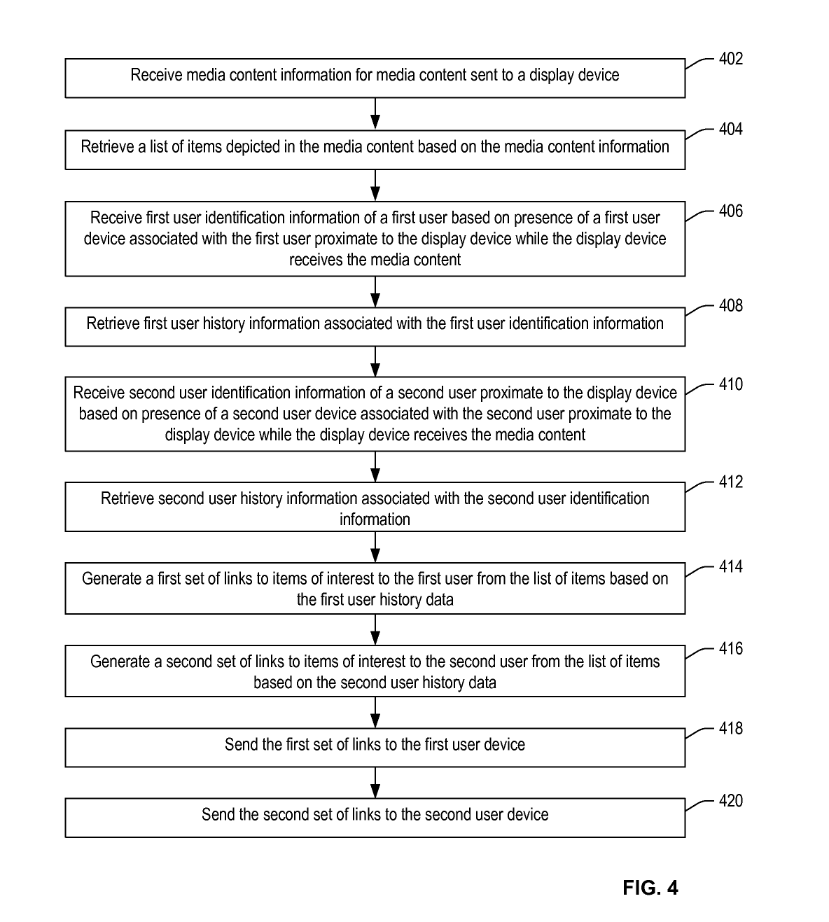

Referring to FIG. 4, a flow chart of a second particular embodiment of a method of providing targeted advertising of products depicted in media content is shown. The method may be performed, for example, by the system 100 of FIG. 1.

At 402, media content information for media content sent to a display device is received. The media content information may be received by an advertising server (e.g., the advertising server 106 of FIG. 1). A list of items depicted in the media content is retrieved, at 404.

At 406, first user identification information of a first user is received based on presence of a first user device associated with the first user being proximate to the display device while the display device receives the media content. For example, a media device may receive information from a residential gateway that the first user device (e.g., a laptop computer) is proximate to the display device. The media device may send identification information for the first user device to the advertising server. First user history information associated with the first user is retrieved, at 408. For example, the advertising server may retrieve user identification information from an OSS/BSS server based on the identification information for the first user device. The advertising server may use the user identification information to retrieve user history information for the first viewer from a user history database.

At 410, second user identification information of a second user is received based on presence of a second user device associated with the second user being proximate to the display device while the display device receives the media content. For example, the media device may receive information from the residential gateway that the second user device (e.g., a mobile communication device) is proximate to the display device. Second user history information associated with the second user is retrieved, at 412. For example, the advertising server may retrieve user identification information from the OSS/BSS server based on the identification information for the second user device. The advertising server may use the user identification information to retrieve user history information for the second viewer from the user history database.

At 414, a first set of links to items of interest to the first user is generated from the list of items based on the first user history information. At 416, a second set of links to items of interest to the second user is generated from the list of items based on the second user history information.

At 418, the first set of links are sent to the first user device. The first set of links may be sent in response to receipt of a request for the first set of links received from the first user device in response to a notification sent to the first user device. At 420, the second set of links are sent to the second user device. The second set of links may be sent in response to receipt of a request for the second set of links received from the second user device in response to a notification sent to the second user device.

Various embodiments disclosed herein enable targeted advertising of items shown in media content to be sent to viewers who may have an interest in the items. The targeted advertising may be used to enable viewers to buy items shown in the media content. The targeted advertising may allow an advertiser to emphasize items that appear in the media content. Providing targeted advertising to items shown in the media content may allow advertisers and advertising providers to overcome waning advertising potential associated with viewers skipping commercials when viewing the media content.

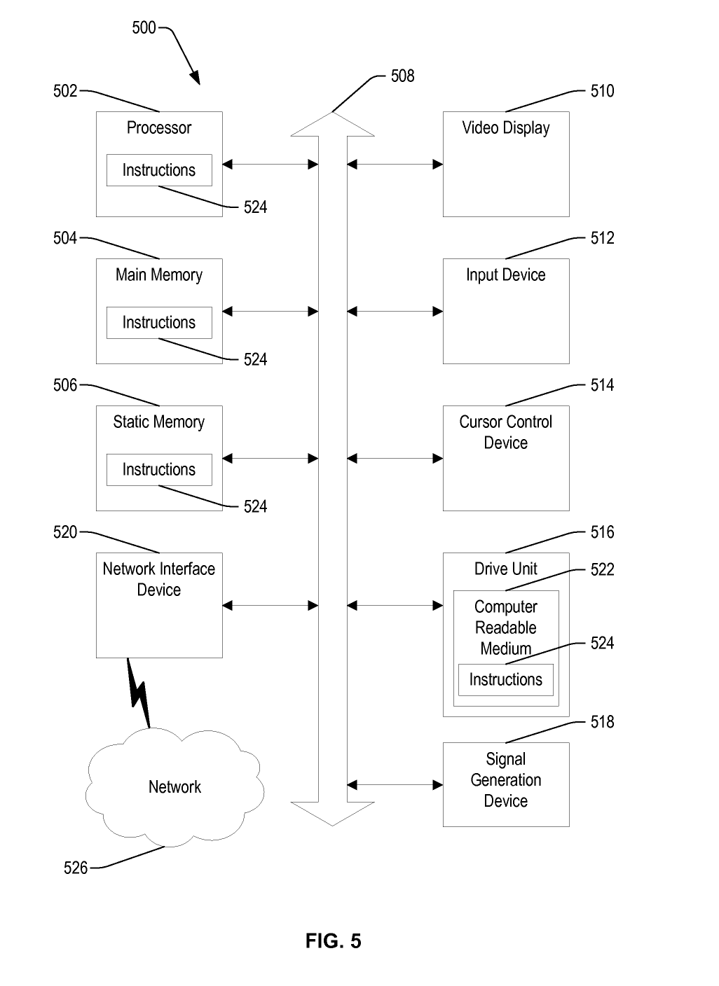

Referring to FIG. 5, an illustrative embodiment of a general computer system is shown and is designated 500. The computer system 500 may include a set of instructions that can be executed to cause the computer system 500 to perform any one or more of the methods or computer based functions disclosed herein. The computer system 500 may operate as a standalone device or may be connected, e.g., using a network, to other computer systems or peripheral devices. For example, the computer system 500 may include or be included within any one or more of the display device 102, the media device 104, the advertising server 106, the CPE 112, the computer system 118, the first portable computing device 120, and the second portable computing device 122 described with reference to FIG. 1.

In a networked deployment, the computer system 500 may operate in the capacity of a server or as a client user computer in a server-client user network environment, or as a peer computer system in a peer-to-peer (or distributed) network environment. The computer system 500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a web appliance, or any other machine capable of executing a set of instructions (sequential or otherwise) that specify actions to be taken by that machine. In a particular embodiment, the computer system 500 may be implemented using electronic devices that provide video, audio, or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 may include a main memory 504 and a static memory 506, which can communicate with each other via a bus 508. As shown, the computer system 500 may further include a video display unit 510, such as a liquid crystal display (LCD), a projection television display, a flat panel display, or a solid state display. Additionally, the computer system 500 may include an input device 512, such as a keyboard, and a cursor control device 514, such as a mouse. The computer system 500 may also include a disk drive unit 516, a signal generation device 518, such as a speaker or remote control, and a network interface device 520. Some computer systems 500 may not include an input device (e.g., a server may not include an input device).

In a particular embodiment, as depicted in FIG. 5, the disk drive unit 516 may include a computer-readable non-transitory storage medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable non-transitory storage media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a tangible computer-readable non-transitory storage medium 522 that stores instructions 524 or receives, stores and executes instructions 524, so that a device connected to a network 526 may communicate voice, video or data over the network 526. While the tangible computer-readable storage medium is shown to be a single medium, the term “tangible computer-readable medium” includes a single medium or multiple media, such as a centralized or distributed database, and/or associated caches and servers that store one or more sets of instructions. The term “tangible computer-readable medium” shall also include any medium that is capable of storing a set of instructions for execution by a processor or that cause a computer system to perform any one or more of the methods or operations disclosed herein.

In a particular non-limiting, exemplary embodiment, the tangible computer-readable storage medium may include a solid-state memory such as a memory card or other package that houses one or more non-volatile read-only memories. Further, the tangible computer-readable storage medium may be a random access memory or other volatile re-writable memory. Additionally, the tangible computer-readable storage medium may include a magneto-optical or optical medium, such as a disk or tapes or other storage device. Accordingly, the disclosure is considered to include any one or more of a tangible computer-readable storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system comprising:
a processor; and
a memory accessible to the processor, the memory comprising instructions executable by the processor to:
receive user identification information for a viewer of a media device;
retrieve user history information for the viewer from a user history database based on the user identification information;
receive media content information for media content sent by the media device to a display device;
retrieve a list of items depicted in the media content from a media content items database;
determine one or more items of interest from the list of items based on the user history information;
generate links to the one or more items of interest; and
send the links to at least one device associated with the viewer.

2. The system of claim 1, wherein the memory comprises instructions executable by the processor to:
provide a notification to a first device of availability of the links; and
receive a request for the links in response to the notification, wherein the links are sent to the at least one device associated with the viewer in response to the request.

3. The system of claim 2, wherein the notification is sent to the display device.

4. The system of claim 2, wherein the at least one device is a portable device associated with the viewer that is in proximity to the media device, and wherein the notification is sent to the portable device.

5. The system of claim 4, wherein the portable device comprises one of a laptop computer, a tablet computer, and a mobile communication device.

6. The system of claim 1, wherein the user identification information is associated with a data service, a television service, and a mobile communication service of the viewer.

7. The system of claim 1, wherein the user identification information is based on user input.

8. The system of claim 1, wherein the user identification information is sent in response to determining that the at least one device is proximate to the media device.

9. The system of claim 1, wherein the user history information comprises at least one of purchase data, location information, and website access data.

10. The system of claim 1, wherein selection of a first link of the links with a particular device causes the particular device to display an offer for purchase of an item associated with the first link.

11. A method comprising:
receiving, at an advertising server, media content information for media content sent to a display device coupled to a media device;
retrieving a list of items depicted in the media content based on the media content information;
receiving, at the advertising server, user identification information of a viewer of the media content;
retrieving user history information associated with the user identification information; and
determining, at the advertising server, one or more items of interest to the viewer from the list of items based on the user history information.

12. The method of claim 11, further comprising:
sending a notification of the availability of items of interest to a first user device associated with the viewer;
receiving a response to the notification to send the one or more items of interest to a second user device associated with the viewer; and
sending links to the one or more items of interest to the second user device.

13. The method of claim 12, wherein the notification is sent after the one or more items of interest to the viewer are determined.

14. The method of claim 12, further comprising updating the links to change as the media content sent to the display device changes.

15. The method of claim 12, wherein the first user device is the display device and the second user device is at least one of the display device, a computer system, and a portable computing device.

16. The method of claim 12, wherein the first user device and the second user device are a portable computing device.

17. The method of claim 11, wherein the media content sent to the display device is media content streamed to the media device from a service provider.

18. The method of claim 11, wherein the media content sent to the display device is recorded media content played from a memory of the media device.

19. A tangible computer readable medium comprising instructions, that when executed by a processor, cause the processor to:
receive media content information for media content sent to a display device;
retrieve a list of items depicted in the media content based on the media content information;
receive first user identification information of a first user based on presence of a first user device associated with the first user proximate to the display device while the display device receives the media content;
retrieve first user history information associated with the first user identification information;
receive second user identification information of a second user proximate to the display device based on presence of a second user device associated with the second user proximate to the display device while the display device receives the media content;
retrieve second user history information associated with the second user identification information;
generate a first set of links of items of interest to the first user from the list of items based on the first user history information; and
generate a second set of links of items of interest to the second user from the list of items based on the second user history information.

20. The tangible computer readable medium of claim 19, wherein the first set of links includes at least one link not included in the second set of links.
